(19) United States
(12) Patent Application Publication
(10) Pub. No.: US 2023/0345857 A1
(43) Pub. Date: Nov. 2, 2023

(54) CALIBRATION MODE OF AN AGRICULTURAL SYSTEM

(71) Applicant: CNH Industrial America LLC, New Holland, PA (US)

(72) Inventors: Brett McClelland, Chicago, IL (US); Christopher Alan Foster, MOHNTON, PA (US); Timothy S. Hunt, Davenport, IA (US)

(21) Appl. No.: 17/731,065

(22) Filed: Apr. 27, 2022

(51) Int. Cl. A01B 79/00; F15B 19/00

(52) U.S. Cl. CPC A01B 79/005; F15B 19/002

(57) ABSTRACT

An agricultural system includes a plurality of components, a plurality of valves configured to control fluid flow to the plurality of components to control actuation of the plurality of components, and a controller having a processor and a memory. The controller is configured to operate the agricultural system in a calibration mode to associate respective valves of the plurality of valves with actuation control of respective components of the plurality of components, determine a calibration based on associating the respective valves with the actuation control of the respective component, receive an indication to actuate a target component of the plurality of components, and output a control signal to a valve associated with the target component based on the calibration in response to receipt of the indication.

### BACKGROUND

The disclosure relates generally to control of an agricultural system and, more specifically, to using a calibration mode to facilitate control of different components of the agricultural system.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of any kind.

An agricultural system may include a work vehicle and an agricultural implement coupled to one another. For example, the agricultural implement may include a tilling implement, a seeding implement, a planting implement, a digging implement, or any other suitable attachment that may be coupled to the work vehicle. During operation of the agricultural system, the work vehicle may move the agricultural implement through a field. In some embodiments, hydraulic fluid may be used to control operation of the agricultural implement and/or the work vehicle. For example, hydraulic fluid may flow between flow paths of the work vehicle and the agricultural implement to actuate various components (e.g., of the agricultural implement and/or the work vehicle). For example, respective flow paths of the work vehicle may be fluidly coupled to respective flow paths of the agricultural implement to enable the flow of hydraulic fluid to operate the components of the agricultural implement. Unfortunately, it may be complicated or tedious to determine how the respective flow paths are connected with one another. Thus, it may be difficult to determine how components of the agricultural implement react in response to varying the flow of hydraulic fluid through the different flow paths.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, an agricultural system includes a plurality of components, a plurality of valves configured to control fluid flow to the plurality of components to control actuation of the plurality of components, and a controller having a processor and a memory. The controller is configured to operate the agricultural system in a calibration mode to associate respective valves of the plurality of valves with actuation control of respective components of the plurality of components, determine a calibration based on associating the respective valves with the actuation control of the respective component, receive an indication to actuate a target component of the plurality of components, and output a control signal to a valve associated with the target component based on the calibration in response to receipt of the indication

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural system having a work vehicle and an agricultural implement, in accordance with an aspect of the present disclosure;

FIG. 2 is a schematic diagram of an embodiment of the agricultural system of FIG. 1, including a hydraulic system for controlling operation of the agricultural implement, in accordance with an aspect of the present disclosure;

FIG. 3 is a flowchart of an embodiment of a method for operating the agricultural system of FIGS. 1 and 2 in a calibration mode, in accordance with an aspect of the present disclosure; and

FIG. 4 is a flowchart of an embodiment of a method for operating the agricultural system of FIGS. 1 and 2 in a normal operating mode based on a calibration determined in a calibration mode, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Embodiments of the present disclosure relate to an agricultural system having an agricultural implement configured to perform an agricultural operation within a field. The agricultural system may include a hydraulic system configured to direct fluid to various components of the agricultural system to operate the components. For example, the hydraulic system may include valves that control fluid flow to certain components of the agricultural system to cause the components to actuate (e.g., move, apply a force, engage an object) during operation of the agricultural system.

In certain agricultural systems, the hydraulic system may be manually configured or arranged to direct the fluid flow to components of the agricultural system. For example, a work vehicle may include a fluid reservoir and first flow paths (e.g., conduits, piping, tubing) through which the fluid may flow into and out of the fluid reservoir. The work vehicle may also include first interfaces (e.g., ports) at the first flow paths that may enable fluid flow into and out of the work vehicle. An agricultural implement may include second flow paths (e.g., conduits, piping, tubing) that may direct fluid into and out of respective components (e.g., hydraulic cylinders, hydraulic accumulators, hydraulic valves of the components to enable, control, and store fluid flow and/or pressure) of the agricultural implement to enable operation, such as movement, of the components. The agricultural implement may also include second interfaces (e.g., ports) at the second flow paths that may enable fluid flow into and out of the agricultural implement. The work vehicle may further include valves (e.g., hydraulic valves, electro-hydraulic valves) disposed along the first flow paths for controlling fluid flow through the first flow paths, thereby controlling fluid flow through corresponding components of the agricultural implement. Thus, the valves may be controlled to operate various components of the agricultural implement.

A user may manually couple connectors (e.g., hoses, conduits) between respective first flow paths of the work vehicle and respective second flow paths of the agricultural implement to enable fluid flow between the fluid reservoir and components of the agricultural implement. For example, the connectors may be secured or coupled to the first interfaces of the work vehicle and the second interfaces of the agricultural implement. Further, a control system may output control signals to the valves to control fluid flow between the work vehicle and the agricultural implement via the connectors during operation of the agricultural system. However, it may be difficult to arrange the connectors to enable desirable control of the agricultural implement components via the control signals output to the valves. For instance, the user may desire that each valve control actuation of a specific component of the agricultural implement. But, it may be tedious to attach, route, and/or position the connectors (e.g., to couple specific first interfaces to specific second interfaces) in a particular manner to enable such control of the agricultural implement components. Additionally or alternatively, a connector may not be arranged in a desirable manner (e.g., the connector may cause a valve to control fluid flow and actuate an undesirable component and/or cause an undesirable actuation of a component). As such, the connector may have to be manually adjusted (e.g., decoupled, moved, recoupled) to enable desirable operation of the agricultural implement.

Thus, it is presently recognized that determining how valves control actuation (e.g., movement, application of force, engagement) of different components and outputting control signals based on such a determination may facilitate desirable operation of the agricultural system. Accordingly, embodiments of the present disclosure are directed to systems and methods for operating the agricultural system in a calibration mode to determine how different valves control respective components of the agricultural implement and/or whether the valves control desirable actuation of the components (e.g., a single valve controls actuation of a single corresponding component). For example, in the calibration mode, a control system may output control signals to the valves and determine which component(s) of the agricultural implement actuate and/or the manner in which the component(s) actuate in response to output of each control signal to a respective valve. Thus, the control system may associate each valve with control of particular component(s) and/or a particular actuation, and the control system may determine how control signals are to be output to the valves based on such association. As an example, based on a calibration determined during the calibration mode, the control system may determine that a first control signal output to a first valve causes actuation of a first component, and a second control signal output to a second valve causes actuation of a second component. As a result, the control system may output the first control signal in response to an indication or determination that the first component is to be actuated, and the control system may output the second control signal in response to an indication or determination that the second component is to be actuated. Additionally or alternatively, the control system may determine that a first control signal output to a valve causes first actuation of a component, and a second control signal output to a valve causes second actuation, different from the first actuation, of the component. In this manner, the control system may output control signals to operate the agricultural implement components in a desirable manner (e.g., to actuate a target component, to enable a target type of actuation of a component) for any arrangement of the fluid connections between the respective flow paths. Although the present disclosure primarily discusses outputting control signals to the valves to operate components of the agricultural implement, in additional or alternative embodiments, the control signals may be output to valves to operate components of the work vehicle or any other suitable component of the agricultural system.

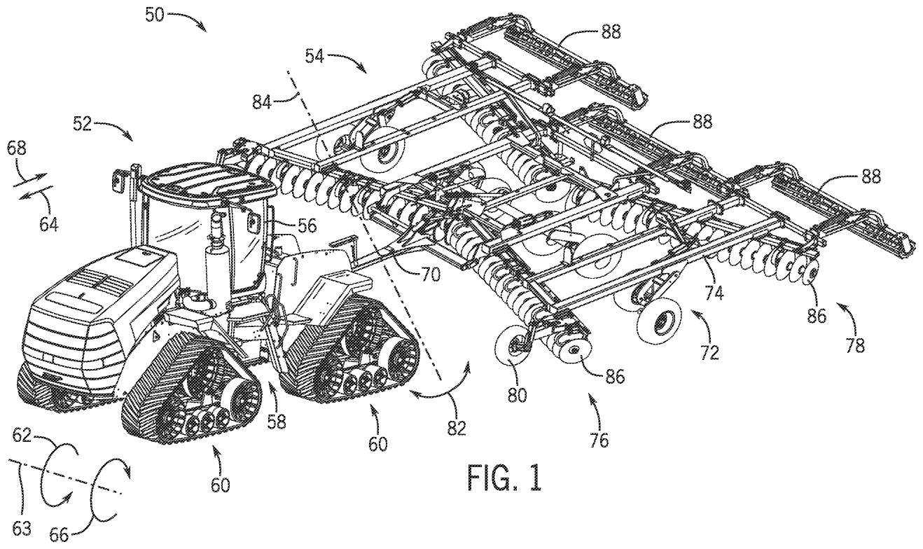

Turning to the drawings, FIG. 1 is a perspective view of an embodiment of an agricultural system 50 that includes a work vehicle 52 and an agricultural implement 54. In the illustrated embodiment, the work vehicle 52 is a tractor. However, in some embodiments, the work vehicle 52 may be an on-road truck, a harvester, and so forth, that may be driven over a field, such as a farming field. As illustrated, the work vehicle 52 includes a cab 56 mounted on a chassis 58. The chassis 58 may support components, such as a motor, a hydraulic system (e.g., a pump, valves, a reservoir), an electrical system (e.g., a control system), a cooling system (e.g., an engine coolant system, a heating, ventilation, and/or air conditioning system), and the like, to facilitate operation of the work vehicle 52. Additionally, the work vehicle 52 includes tracks and/or wheels 60 that operate to move the work vehicle 52. For example, the front and/or the rear tracks 60 may rotate in a first rotational direction 62 (e.g., a forward rotational direction) about a lateral axis 63 to drive the work vehicle 52 in a first direction 64 (e.g., a forward direction), and the front and/or rear tracks 60 may rotate in a second rotational direction 66 (e.g., reverse rotational direction) about the lateral axis 63, opposite the first rotational direction 62, to drive the work vehicle 52 in a second direction 68 (e.g., backward direction), opposite the first direction 64. The tracks 60 (e.g., the front tracks and/or the rear tracks) may also be steered to turn the work vehicle 52. In additional or alternative embodiments, a portion (e.g., a rear portion) of the chassis may rotate relative to a remaining portion (e.g., a front portion) of the chassis to steer the work vehicle. Further, while the illustrated work vehicle 52 includes tracks 60, the work vehicle may include wheels in an additional or an alternative embodiment.

The cab 56 is configured to house an operator of the work vehicle 52 during operation of the agricultural system 50. The cab 56 may provide access to various controls of the work vehicle 52. For example, the cab 56 may include a user interface to enable the operator to control the operation of certain systems of the work vehicle 52. In some embodiments, the cab 56 may include a component, such as a steering wheel, to enable the operator to steer the tracks 60 to turn the work vehicle 52. In addition, the cab may include other and/or additional types of user interfaces (e.g., a touch screen, a hand controller, a push button, a track pad) configured to receive user input or feedback for controlling various operations and systems of the work vehicle 52 and/or the agricultural implement 54.

Moreover, the chassis 58 is coupled to the agricultural implement 54 to enable the work vehicle 52 to tow the agricultural implement 54. For example, the chassis 58 may be coupled to a hitch 70 of the agricultural implement 54 (e.g., via a corresponding hitch of the work vehicle). In alternative embodiments, the agricultural implement may be located at any position (e.g., behind, in front of, on the side) relative to the work vehicle. In addition, the agricultural implement 54 includes main wheels 72 that enable the agricultural implement 54 to move, such as over the field through which the work vehicle 52 is navigating. Thus, movement of the work vehicle 52 drives movement of the agricultural implement 54. For example, movement of the work vehicle 52 in the first direction 64 drives the agricultural implement 54 to move in the first direction 64, and movement of the work vehicle 52 in the second direction 68 drives the agricultural implement 54 to move in the second direction 68. In certain embodiments, the agricultural implement 54 may also be steerable. By way of example, the main wheels 72 may be turned to steer the agricultural implement 54.

The agricultural implement 54 may include various components that may actuate, such as move, apply a force, engage an object (e.g., soil), and so forth, during operation of the agricultural system 50. In the illustrated embodiment, the agricultural implement 54 is a tilling implement (e.g., a vertical tilling implement). However, the agricultural implement may be any other suitable implement (e.g., a primary tillage implement, a planting implement, a seeding implement, a mowing implement) in additional or alternative embodiments. The illustrated agricultural implement 54 includes a frame 74 to which the main wheels 72 are coupled. As illustrated in FIG. 1, the main wheels 72 are located between a first end 76 (e.g., front end) of the agricultural implement 54 and a second end 78 (e.g., rear end) of the agricultural implement 54. The agricultural implement 54 includes gauge wheels 80 that are coupled to the frame 74, such as at the first end 76. The gauge wheels 80 may be used to reduce an amount of lateral and/or vertical movement of the agricultural implement 54 while the agricultural system 50 is in operation. For example, the gauge wheels 80 may engage the soil surface while the work vehicle 52 tows the agricultural implement 54, such that movement of the agricultural implement 54 along the lateral axis 63 and/or movement of the agricultural implement 54 (e.g., in a rotational direction 82) along a vertical axis 84 is reduced.

The agricultural implement 54 also includes disc blades 86 that are coupled to the frame 74. During operation of the agricultural system 50, the disc blades 86 may engage soil of the field. For instance, the main wheels 72 may be positioned to set the position of the frame 74 at a target height above the soil surface. By way of example, the main wheels 72 may move (e.g., translate, rotate) away from the frame 74 to drive the frame 74 away from the soil surface, and the main wheels 72 may move toward the frame 74 to drive the frame 74 toward the soil surface. As the agricultural implement 54 is towed by the work vehicle 52, the disc blades 86 may rotate while engaged with the soil to till the soil. Each disc blade 86 may, for example, be non-translatably coupled to the frame 74, such that movement of the main wheels 72 relative to the frame 74 changes the position of the disc blades 86 relative to the soil surface (e.g., to engage or disengage the disc blades 86 from the soil). In some embodiments, the disc blades 86 may be concave and/or may have certain surface features (e.g., flutes) that facilitate tilling of the soil. In additional or alternative embodiments, the agricultural implement may include other suitable type(s) of ground engaging tool(s), such as tillage points, tines, shanks, and so forth.

Although the position of the disc blades 86 relative to the soil surface is adjusted by controlling the position of the main wheels in the illustrated embodiment, in additional or alternative embodiments, the position of the disc blades may be adjusted in other manners. For example, the hitch may be raised and/or lowered relative to the soil surface (e.g., via adjustment of the hitch of the work vehicle) to adjust the position and/or a pitch of the agricultural implement, thereby adjusting the position of the disc blades relative to the soil surface. In further embodiments, the position and/or orientation of the disc blades may be adjustable relative to the implement frame. For example, groups of disc blades may be moved/rotated relative to the frame via a subframe of the agricultural implement.

The agricultural implement 54 may also include basket assemblies 88, which may be disposed at the second end 78 of the agricultural implement 54. The basket assemblies 88 are configured to engage the soil surface during operation of the agricultural system 50. For example, as the work vehicle 52 tows the agricultural implement 54 in the first direction 64, each basket assembly 88 may provide a downward force on the soil and rotate to break clods and level the soil tilled by the disc blades 86. Although the agricultural implement 54 has three basket assemblies 88 in the illustrated embodiment, additional or alternative embodiments of the agricultural implement may have any suitable number of basket assemblies and/or any other suitable component(s) (e.g., tines) configured to level the soil during operation of the agricultural system. In some embodiments, the basket assemblies 88 may also stabilize the agricultural implement 54 during operation of the agricultural system 50. For example, the basket assemblies 88 may dampen vertical movement of the agricultural implement 54 by providing a downward pressure.

It should be noted that the agricultural system 50 may have any suitable alternate configuration, such as having additional components, having different components, lacking certain components described above, or a combination thereof For example, any suitable agricultural implement, such as a mower, a baler, a sprayer, a planter, a seeder, and so forth, may be attachable to the work vehicle to enable the agricultural system to perform a corresponding operation. Furthermore, the agricultural system 50 may include any other suitable system, such as a combine and header embodiment. In some embodiments, any of the components (e.g., the hitch 70, the main wheels 72, the gauge wheels 80, the disc blades 86, the basket assemblies 88) of the agricultural system 50 may be movable via a hydraulic system of the agricultural system 50. For example, the hydraulic system may include conduits configured to direct a fluid (e.g., oil) into and/or out of a part (e.g., a hydraulic cylinder) of the component to move the component. In this manner, the flow of the fluid may be controlled to control operation of the agricultural implement components. In certain embodiments, the fluid flow may be automatically controlled, such as via a control scheme or operation (e.g., for an automated agricultural system or an automated operation of the agricultural system). Additionally or alternatively, the fluid flow may be controlled via a user input, such as via a user interface positioned within the cab 56.

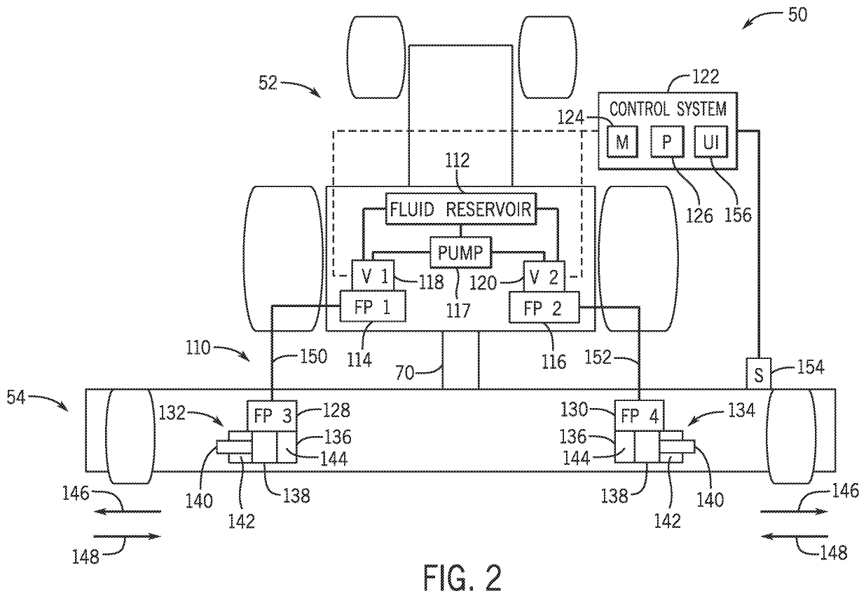

FIG. 2 is a schematic diagram of an embodiment of the agricultural system 50 of FIG. 1, including a hydraulic system 110 (e.g., a fluid system, a conduit system) configured to control operation of the agricultural implement 54. The hydraulic system 110 may direct a fluid to move through the agricultural system 50 to actuate components of the agricultural implement 54. For example, the hydraulic system 110 may include a fluid reservoir 112, which may be positioned in and/or on the work vehicle 52. The hydraulic system 110 may include a first flow path 114 and a second flow path 116 of the work vehicle 52. Each of the first flow path 114 and the second flow path 116 may be configured to enable fluid flow into and/or out of the fluid reservoir 112. As an example, the hydraulic system 110 may include a pump 117 configured to direct the fluid from the fluid reservoir 112 toward the first flow path 114 and/or the second flow path 116, and/or to direct the fluid from the first flow path 114 and/or the second flow path 116 into the fluid reservoir 112.

Further, a first valve 118 (e.g., a first electro-hydraulic remote valve) may be positioned to control fluid flow through the first flow path 114, and a second valve 120 (e.g., a second electro-hydraulic remote valve) may be positioned to control fluid flow through the second flow path 116. By way of example, each of the valves 118, 120 may be controllable via respective control signals being output to the valves 118, 120. In some embodiments, a control signal may cause a corresponding one of the valves 118, 120 to transition to a first position (e.g., an open position) that enables fluid flow through the associated first flow path 114 or second flow path 116 (e.g., from the fluid reservoir 112 toward the first flow path 114 and/or toward the second flow path 116, from the first flow path 114 and/or from the second flow path 116 into the fluid reservoir 112). In addition, a control signal may cause a corresponding one of the valves 118, 120 to close, thereby blocking fluid flow through the associated first flow path 114 or second flow path 116. Furthermore, in certain embodiments, a control signal may cause a corresponding one of the valves 118, 120 to adjust between a plurality of open positions (e.g., intermediate positions) in order to adjust a flow rate of fluid flow through the associated first flow path 114 or second flow path 116 to enable greater control (e.g., of a speed and/or an acceleration of movement) of respective component(s) of the agricultural implement 54.

To this end, the agricultural system 50 may include a control system 122 (e.g., an automated controller), which may include one or more controllers positioned at the work vehicle 52, at the agricultural implement 54, or both. The control system 122 may include a memory 124 and processing circuitry 126. The memory 124 may include volatile memory, such as random-access memory (RAM), and/or non-volatile memory, such as read-only memory (ROM), optical drive(s), hard disc drive(s), solid-state drive(s), or any other non-transitory computer readable medium that includes instructions executable by the processing circuitry 126. The processing circuitry 126 may include one or more application specific integrated circuits (ASICs), one or more field programmable gate arrays (FPGAs), one or more general purpose processors (e.g., microprocessors), or any combination thereof, configured to execute the instructions stored in the memory 124 to operate the agricultural system 50. For example, the instructions stored in the memory 124 may cause the processing circuitry 126 to output one or more control signals to the valves 118, 120 to control fluid flow through the respective flow paths 114, 116.

The hydraulic system 110 may also include a third flow path 128 and a fourth flow path 130 of the agricultural implement 54. In the illustrated embodiment, the third flow path 128 is fluidly coupled to a first hydraulic cylinder 132, and the fourth flow path 130 is fluidly coupled to a second hydraulic cylinder 134. Thus, the third flow path 128 may enable fluid flow into and/or out of the first hydraulic cylinder 132, and the fourth flow path 130 may enable fluid flow into and/or out of the second hydraulic cylinder 134. Each of the hydraulic cylinders 132, 134 may be a part of respective component(s) of the agricultural implement 54, and fluid flow through the hydraulic cylinders 132, 134 may cause actuation of corresponding components of the agricultural implement 54. For instance, each of the hydraulic cylinders 132, 134 includes a body 136 and a piston 138 disposed within the body 136. Each piston 138 includes a rod 140 that extends through the body 136. Each piston 138 fluidly separates the corresponding body 136 into a rod section 142 and a cap section 144. That is, the piston 138 may substantially block fluid flow between the rod section 142 and the cap section 144. Additionally, the piston 138 is movable within the body 136 in response to a fluid pressure differential between the rod section 142 and the cap section 144. For example, increasing the fluid pressure in the cap section 144 and/or decreasing the fluid pressure in the rod section 142 may increase pressurization to drive the piston 138 to move in a first direction 146 to extend the rod 140 farther out of the body 136. Further, increasing the fluid pressure in the rod section 142 and/or decreasing the fluid pressure in the cap section 144 may increase pressurization to drive the piston 138 to move in a second direction 148, opposite the first direction 146, to retract the rod 140 farther into the body 136. Increasing pressurization in the hydraulic cylinders 132, 134 may cause actuation of a corresponding component of the agricultural system 50. For example, each rod 140 may be coupled to the component (e.g., via a linkage system), and directing fluid into and/or out of the hydraulic cylinders 132, 134 may drive movement of the piston 138 and the rod 140 to cause movement of the component and/or may increase a pressurization within the hydraulic cylinders 132, 134 to drive the piston 138 and the rod 140 to increase a pressure imparted by the component onto an object.

In some embodiments, each of the third flow path 128 and the fourth flow path 130 may be fluidly coupled to a corresponding cap section 144 and may therefore control fluid flow into and/or out of the cap section 144 to control movement of the piston 138 and the rod 140 relative to the body 136. Additionally or alternatively, either of the third flow path or the fourth flow path may be fluidly coupled to a corresponding rod section and may therefore control fluid flow into and/or out of the rod section to control movement of the piston and the rod relative to the body. In a further embodiment, either of the third flow path or the fourth flow path may be fluidly coupled to both the corresponding cap section and the rod section. For example, a first portion of the third flow path may control fluid flow into and/or out of the cap section of the first hydraulic cylinder 132, and a second portion of the third flow path may control fluid flow into and/or out of the rod section of the first hydraulic cylinder 132. Similarly, a first portion of the fourth flow path may control fluid flow into and/or out of the cap section of the second hydraulic cylinder 134, and a second portion of the fourth flow path may control fluid flow into and/or out of the rod section of the second hydraulic cylinder 134.

In the illustrated embodiment, a first connector 150 (e.g., a first hose, a first conduit) fluidly couples the first flow path 114 to the third flow path 128 (e.g., a first end of the first connector 150 may be attached to a port or interface of the first flow path 114 and/or of the first valve 118 and a second end of the first connector 150 may be attached to a port or interface of the third flow path 128). Thus, the first connector 150 may enable fluid flow between the first hydraulic cylinder 132 and the fluid reservoir 112 via the first flow path 114 and the third flow path 128, and the first valve 118 may control fluid flow into and/or out of the first hydraulic cylinder 132. Further, a second connector 152 (e.g., a second hose, a second conduit) fluidly couples the second flow path 116 to the fourth flow path 130 (e.g., a first end of the second connector 152 may be attached to a port or interface of the second flow path 116 and/or of the second valve 120 and a second end of the second connector 152 may be attached to a port or interface of the fourth flow path 130). As such, the second connector 152 may enable fluid flow between the second hydraulic cylinder 134 and the fluid reservoir 112 via the second flow path 116 and the fourth flow path 130, and the second valve 120 may control fluid flow into and/or out of the second hydraulic cylinder 134.

In certain embodiments, the first connector 150 may enable fluid flow between the rod section 142 of the first hydraulic cylinder 132 and the first flow path 114, as well as between the cap section 144 of the first hydraulic cylinder 132 and the first flow path 114. For example, a first portion (e.g., a first connection line, a first segment) of the first connector 150 may be fluidly coupled to the rod section 142 of the first hydraulic cylinder 132 and attached to a first interface of the first flow path 114 and/or of the first valve 118, and a second portion (e.g., a second connection line, a second segment) of the first connector 150 may be fluidly coupled to the cap section 144 of the first hydraulic cylinder 132 and attached to a second interface of the first flow path 114 and/or of the first valve 118. As such, the first valve 118 may be configured to control fluid flow between the first flow path 114 and each of the rod section 142 and the cap section 144 of the first hydraulic cylinder 132 via the first portion and the second portion, respectively, of the first connector 150 to cause different types of actuation (e.g., movement in opposite directions) of a corresponding component. Similarly, a first portion of the second connector 152 may be fluidly coupled to the rod section 142 of the second hydraulic cylinder 134 and attached to a first interface of the second flow path 116 and/or of the second valve 120, and a second portion of the second connector 152 may be fluidly coupled to the cap section 144 of the second hydraulic cylinder 134 and attached to a second interface of the second flow path 116 and/or of the second valve 120. Thus, the second valve 120 may be configured to control fluid flow between the second flow path 116 and each of the rod section 142 and the cap section 144 of the second hydraulic cylinder 134 via the first portion and the second portion, respectively, of the second connector 152 to cause different types of actuation of a corresponding component.

Additionally, the first connector 150 and the second connector 152 may be fluidly separate from one another. That is, fluid may not directly flow between the connectors 150, 152. As a result, each of the valves 118, 120 may control fluid flow through the particular connector 150, 152 fluidly coupled to the associated first flow path 114 or second flow path 116. Therefore, operation of the first valve 118 may not affect fluid flow into and/or out of the second hydraulic cylinder 134, and operation of the second valve 120 may not affect fluid flow into and/or out of the first hydraulic cylinder 132.

Although the illustrated agricultural system 50 includes two flow paths 114, 116 of the work vehicle 52, two valves 118, 120 corresponding to the two flow paths 114, 116, two flow paths 128, 130 of the agricultural implement 54, and two connectors 150, 152 fluidly coupling the respective flow paths 114, 116 of the work vehicle 52 with the flow paths 128, 130 of the agricultural implement 54, additional or alternative embodiments of the agricultural system may include any suitable number (e.g., one, three, four or more) of work vehicle flow paths, agricultural implement flow paths, valves, and connectors. Further, the connectors may fluidly couple any of the flow paths of the work vehicle to any of the flow paths of the agricultural implement. For example, a user may manually attach a connector to any one of the flow paths of the work vehicle and to any one of the flow paths of the agricultural implement. The arrangement of the connectors may establish which component(s) is controlled by each of the valves. For instance, a user may arrange the connectors such that the second valve controls fluid flow into and/or out of the first hydraulic cylinder, and the first valve controls fluid flow into and/or out of the second hydraulic cylinder. Further, in some embodiments, another actuator (e.g., an electro-mechanical actuator) may be used to control the component(s).

The control system 122 may be configured to operate the agricultural system 50 in a calibration mode to determine a calibration indicative of how the valves 118, 120 control operation of the components of the agricultural system 50. As an example, during the calibration mode, the control system 122 may determine whether a first control signal output to the first valve 118 moves the first hydraulic cylinder 132 or the second hydraulic cylinder 134, and/or whether a second control signal output to the second valve 120 moves the first hydraulic cylinder 132 or the second hydraulic cylinder 134. As another example, during the calibration mode, the control system 122 may determine a speed in which the first hydraulic cylinder 132 and/or the second hydraulic cylinder 134 may move via control of the valves 118, 120. As a further example, during the calibration mode, the control system 122 may determine the type of actuation caused by controlling the valves 118, 120. For instance, in embodiments in which each valve 118, 120 enables fluid flow to both a corresponding rod section 142 and cap section 144, the control system 122 may determine how adjustment of the valves 118, 120 controls fluid flow to and/or from the corresponding hydraulic cylinders 132, 134 (e.g., the rod section 142, the cap section 144) to cause a certain type of actuation (e.g., direction of movement, type of movement, direction of applied force) of a corresponding component. The control system 122 may then adjust how control signals are output to the valves 118, 120 to move the hydraulic cylinders 132, 134 based on the calibration determined during the calibration mode. For example, during operation of the agricultural system 50, the control system 122 may receive an indication or a request of a target type actuation of target component(s) to be actuated, and the control system 122 may output a control signal to operate the corresponding valve that effectuates the target type of actuation of the target component(s) based on the calibration determined during the calibration mode.

For this reason, the agricultural system 50 may include one or more sensor(s) 154 configured to monitor data indicative of actuation (e.g., movement, position, orientation, state) of the agricultural system 50, such as of the work vehicle 52 and/or of the agricultural implement 54, as controlled by the hydraulic system 110. The sensor(s) 154 may include a position sensor, such as a light detection and ranging sensor, a potentiometer, a radar sensor, an accelerometer, a linear transducer, a force sensor (e.g., a pressure transducer), and the like, configured to monitor a position of various components of the agricultural system 50, a pressure sensor or flow sensor configured to monitor fluid flow through the agricultural system 50 (e.g., through the flow paths 114, 116, 128, 130, through the hydraulic cylinders 132, 134), and/or any other suitable sensor. The control system 122 may receive data from the sensor(s) 154 during the calibration mode to determine the corresponding actuations caused by output of the control signals.

In some embodiments, the control system 122 may automatically receive the indication or request of a target type of actuation of target component(s). As an example, the agricultural system 50 may be an automated system, and the control system 122 may be configured to operate the agricultural system 50 based on various data (e.g., including data received from one of the sensor(s) 154), such as an operation to be performed, a time of operation, a location and/or orientation of the agricultural system 50 in a field, a type of crop on the field, crop conditions (e.g., moisture), crop losses, soil conditions, soil type, crop residue coverage/density, cut quality, another type of data, or any combination thereof. The control system 122 may output the control signals based on the automatically received indication or request. Additionally or alternatively, the control system may receive the indication or request via a user input. For instance, the illustrated control system 122 includes a user interface 156 (e.g., positioned within the cab of the work vehicle 52, positioned remote from the agricultural system 50). The user interface 156 may include one or more of a touch screen, a switch, a paddle, a dial, a knob, a trackpad, a button, another feature, or any combination thereof. A user may interact with the user interface 156 to output the indication or request. By way of example, the user may interact with the user interface 156 to directly indicate a target type of actuation of target component(s) and/or to indicate a desired operation of the agricultural system 50, and the control system 122 may determine the target type of actuation of target component(s) and output corresponding control signal(s) based on the desired operation.

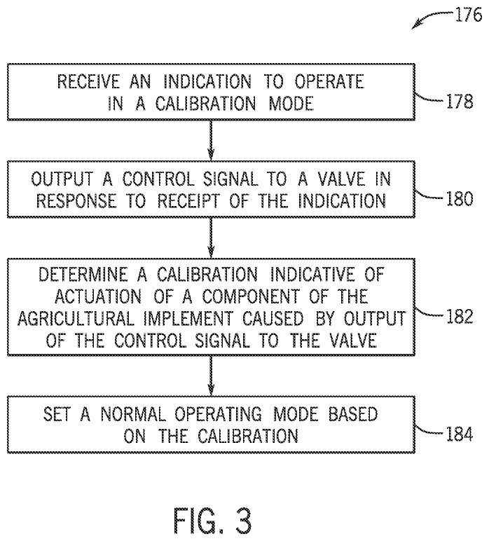

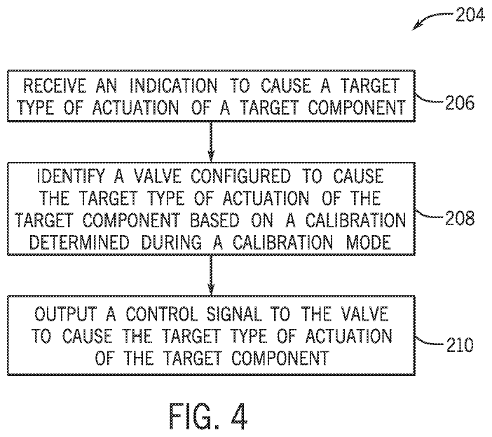

Each of FIGS. 3 and 4 illustrate an embodiment of a respective method or process for operating the agricultural system 50 of FIGS. 1 and 2. In some embodiments, each of the methods may be performed by a single control component, such as the processing circuitry of the control system. In additional or alternative embodiments, multiple control components may perform the steps for at least one of the methods. Furthermore, additional steps may be performed with respect to the described methods. Additionally or alternatively, certain steps of the described methods may be removed, modified, performed in a different order, or a combination thereof. Further still, the steps of any of the respective methods may be performed in parallel with one another, such as at the same time, and/or the step(s) of one of the methods may be performed in response to initiation or completion of the step(s) of another one of the methods.

FIG. 3 is a flowchart of an embodiment of a method 176 for operating the agricultural system 50 of FIGS. 1 and 2 in a calibration mode. At block 178, an indication to operate in a calibration mode may be received. In some embodiments, the indication may be received via a user input, such as via interaction with the user interface. As an example, the user may instruct the user interface to output the indication after changing the arrangement of the connectors fluidly coupling the work vehicle and the agricultural implement to one another. In additional or alternative embodiments, the indication may be associated with an operating parameter (e.g., received from a sensor). For example, the operating may be associated with a particular frequency, such as a scheduled time, a certain amount of operating time elapsed, a number of operations performed, and so forth. The calibration mode may additionally or alternatively be initiated based on a determined status of the agricultural system. By way of example, a determination may be made that the arrangement of the connectors fluidly coupling the work vehicle and the agricultural implement to one another has been adjusted, such as that a new connector has been added, an existing connector has been removed, an existing connector has been moved, or a combination thereof. For instance, the agricultural system may include a sensor (e.g., a contact sensor) that monitors securement of the connectors to the different flow paths, and the sensor may output data indicating that such securements have changed to indicate adjustment of the connectors.

In certain embodiments, prior to initiating the calibration mode, a determination may be made regarding whether the agricultural system is proximate to any external objects that are not a part of the agricultural system (e.g., whether any objects are within a threshold distance of the agricultural system). For example, the agricultural system may include a sensor (e.g., a distance sensor, a proximity sensor, a ranging sensor) configured to detect a location of external objects relative to the agricultural system, such as external objects that may come into contact with the agricultural system during operation in the calibration mode. The calibration mode may be initiated in response to a determination that there are no external objects proximate to the agricultural system (e.g., within the threshold distance of the agricultural system) so as to avoid contact between the agricultural system and the objects during operation in the calibration mode. However, in response to a determination that there is an external object proximate to the agricultural system (e.g., within the threshold distance of the agricultural system), operation in the calibration mode may be blocked.

At block 180, a control signal is output to a valve (e.g., an electro-hydraulic remote valve) upon initiation of the calibration mode. The control signal may adjust a position of the valve to therefore adjust the fluid flow directed through an associated flow path. Component(s) of the agricultural implement may be actuated (e.g., moved) in response to output of the control signal and corresponding adjustment of the fluid flow through the associated path. At block 182, a calibration indicative of the actuation (e.g., a type of actuation) of the component(s) caused by output of the control signal may therefore be determined. In this manner, based on the calibration, a determination may be made that outputting the control signal to the valve causes the corresponding actuation of the particular component(s).

In some embodiments, the control signal being output during the calibration mode may cause limited actuation of the components of the agricultural system (e.g., as compared to actuation of the components during other operating modes of the agricultural system). As an example, in response to a determination that actuation of the component has reached a threshold amount of actuation (e.g., threshold amount of movement, threshold amount of applied force), the control signal may be interrupted or blocked from being further output and/or an additional control signal may be output to terminate actuation of the component (e.g., beyond the threshold amount of actuation). As another example, additional feature(s), such as a bar, a rod, a stopper, another suitable feature, or any combination thereof, may be used during the calibration mode to physically block certain actuation of the component.

At block 184, a normal operating mode of the agricultural system may be set based on the calibration indicative of the identified actuation of the component caused by output of the control signal to the valve. As discussed herein, a normal operating mode of the agricultural system may include any suitable operating mode that is not the calibration mode, such as component control based on sensor feedback and/or component control based on a map of the field. The normal operating mode may be set such that, in response to a determination that a target type of actuation of the component is to be effectuated, a control signal may be output to the valve associated with the target type of actuation of the component (e.g., instead of to another valve of the agricultural system, instead of to cause different actuation of the component). It should be noted that the steps described with respect to blocks 180 and 182 may be repeated for other valves of the agricultural system such that the calibration is indicative of how respective control signals output to the other valves cause actuation of other components of the agricultural implement. The normal operating mode may therefore be set based on the calibration determined for the other components. In this manner, operation in the calibration mode may be performed to associate different valves with different types of actuation of various components of the agricultural implement.

In addition, the calibration mode may be operated to determine a speed of actuation of component(s) of the agricultural implement caused by output of control signal(s) to the valve(s). Thus, the calibration determined during the calibration mode may also be indicative of actuation speed of component(s) caused by output of the control signal(s). As such, the actuation speed of the component(s) may be used to improve control of a component, such as a length of time that a valve is open to actuate the component.

In some embodiments, operation of the agricultural system in the calibration mode may be automatically suspended, such as after a respective control signal has been output to each of the valves (e.g., after each of the valves have been associated with actuation control of a respective component). Indeed, operation of the agricultural system may automatically transition from the calibration mode to the normal operating mode (e.g., the fluid directed to the valves during the calibration mode may be utilized to continue operation of the components in the normal operating mode). In additional or alternative embodiments, operation of the agricultural system in the calibration mode may be suspended in response to receipt of a user input, such as a user input received prior to the respective control signals being output to each of the valves. In other words, the user input may be output prior to completion of operation in the calibration mode to associate each valve with actuation control of a respective component.

In further embodiments, another action may be performed in response to the identified actuation of the component caused by output of the control signal to the valve. As an example, no substantial actuation (e.g., actuation of a component is below a threshold amount of actuation) may be identified upon outputting the control signal to the valve, thereby indicating that fluid flow is not sufficiently enabled between the work vehicle and the agricultural implement (e.g., a connector is not securely coupled to one of the flow paths). In response, a notification may be output to the user, such as to inform the user to inspect the securement of the connectors. As another example, the calibration mode may be used to determine whether a single valve is used to control actuation of the same component. For instance, in embodiments in which a single valve may be used to control fluid flow to and/or from both the cap section and the rod section of a single hydraulic cylinder, the calibration mode may be used to determine whether a valve causes different types of actuations of the same component, thereby indicating the valve is fluidly coupled to a single hydraulic cylinder, or causes actuation of different components, thereby indicating the valve is fluidly coupled to different hydraulic cylinders.

FIG. 4 is a flowchart of an embodiment of a method 204 for operating the agricultural system 50 of FIGS. 1 and 2 in a normal operating mode based on a calibration determined during a calibration mode (e.g., the calibration mode performed via the steps described with respect to the method 176). At block 206, an indication or request to cause a target type of actuation (e.g., movement in a particular direction, a type of movement, application of a force in a certain direction) of target component(s) is received. In some embodiments, the indication may be received via a user input. For example, the user interface of the agricultural system may include features that may cause a respective indication to be output when interacted with by a user. In additional or alternative embodiments, the indication may be received in a different manner (e.g., without a user input), such as via sensor data. The indication to actuate the target component may also be programmed (e.g., as part of a control scheme).

At block 208, a valve (e.g., an electro-hydraulic remote valve) configured to provide the target type of actuation of the target component(s) may be identified based on the calibration determined via the calibration mode. Indeed, based on the calibration, each valve may be associated with actuation control of respective component(s). Thus, a corresponding valve may be selected based on its association with actuation control of the target component(s) based on the calibration. Furthermore, different adjustments of the valve (e.g., to enable fluid flow to one of a rod section or a cap section of a hydraulic cylinder) may be associated with causing respective types of actuation of the target component based on the calibration. Thus, the adjustment of the valve to cause the target type of actuation of the target component may be determined based on the calibration. At block 210, a control signal may be output to the valve to cause the type of adjustment of the target component(s).

In this manner, based on the calibration, control signal(s) may be output to cause an indicated or requested target type of actuation of any target component(s) regardless of the arrangement of the connectors between the work vehicle and the agricultural implement. As such, operation in the calibration mode may enable the connectors to be more easily installed in the agricultural system (e.g., to couple any of the flow paths of the work vehicle to any of the flow paths of the agricultural implement) while enabling desirable operation of the agricultural system.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An agricultural system, comprising:
a plurality of components;
a plurality of valves configured to control fluid flow to the plurality of components to control actuation of the plurality of components; and
a controller comprising a processor and a memory, wherein the controller is configured to perform operations comprising:
operating the agricultural system in a calibration mode to associate respective valves of the plurality of valves with actuation control of respective components of the plurality of components;
determining a calibration based on associating the respective valves with the actuation control of the respective components;
receiving an indication to actuate a target component of the plurality of components; and
outputting a control signal to a valve associated with the target component based on the calibration in response to receipt of the indication.

2. The agricultural system of claim 1, wherein, during operation of the agricultural system in the calibration mode, the controller is configured to perform operations comprising:
outputting respective additional control signals to the plurality of valves to adjust the fluid flow to the plurality of components;
identifying corresponding actuation of the plurality of components caused by output of the respective additional control signals;
associating the respective valves of the plurality of valves with the actuation control of the respective components of the plurality of components based on the corresponding actuation of the plurality of components caused by the output of the respective additional control signals; and
determining the calibration based on associating the respective valves with the actuation control of the respective components.

3. The agricultural system of claim 2, comprising a sensor communicatively coupled to the controller and configured to monitor the actuation of the plurality of components, wherein the controller is configured to identify the corresponding actuation of the plurality of components based on data received from the sensor.

4. The agricultural system of claim 3, wherein the sensor comprises a position sensor, a pressure sensor, a force sensor, a movement sensor, a flow sensor, or any combination thereof.

5. The agricultural system of claim 1, comprising a fluid reservoir and a plurality of connectors configured to fluidly couple the fluid reservoir to the plurality of components, wherein the plurality of valves are configured to control fluid flow to the plurality of components via the plurality of connectors, and the controller is configured to operate the agricultural system in the calibration mode in response to a detection of an adjustment of an arrangement of the plurality of connectors.

6. The agricultural system of claim 1, comprising the target component, wherein the target component comprises a hydraulic cylinder, the valve associated with the target component is configured to control fluid flow through the hydraulic cylinder, and the controller is configured to output the control signal to the valve to direct the fluid flow to move a piston of the hydraulic cylinder and cause actuation of the target component in response to receipt of the indication.

7. The agricultural system of claim 1, wherein the plurality of valves comprises an electro-hydraulic remote valve.

8. The agricultural system of claim 1, wherein the controller is configured to receive the indication to actuate the target component via a user input.

9. A non-transitory computer-readable medium comprising instructions, wherein the instructions, when executed by processing circuitry, are configured to cause the processing circuitry to perform operations comprising:
operating an agricultural system in a calibration mode to determine a calibration that associates respective valves of a plurality of valves of the agricultural system with actuation control of each component of a plurality of components of the agricultural system, wherein each valve of the plurality of valves controls fluid flow to an associated component of the plurality of components to control actuation of the associated component;
operating the agricultural system in a normal operating mode;
receiving an indication to actuate a target component of the plurality of components of the agricultural system during operation of the agricultural system in the normal operating mode; and
outputting a control signal to the valve associated with the target component based on the calibration in response to receipt of the indication.

10. The non-transitory computer-readable medium of claim 9, wherein the instructions, when executed by the processing circuitry, are configured to cause the processing circuitry to perform operations comprising:
outputting a respective additional control signal to each valve of the plurality of valves to adjust the fluid flow directed to the plurality of components during operation of the agricultural system in the calibration mode;
identifying corresponding actuation of the plurality of components caused by output of the respective additional control signals;
associating the respective valves of the plurality of valves with the actuation control of each component of the plurality of components based on identification of the corresponding actuation of the plurality of components caused by the output of the respective additional control signals; and
determining the calibration based on associating the respective valves with the actuation control of each component.

11. The non-transitory computer-readable medium of claim 10, wherein the instructions, when executed by the processing circuitry, are configured to cause the processing circuitry to transition from the calibration mode to the normal operating mode upon determining the calibration.

12. The non-transitory computer-readable medium of claim 9, wherein the instructions, when executed by the processing circuitry, are configured to cause the processing circuitry to operate the agricultural system in the calibration mode in response to receipt of a user input, of sensor data indicative of an operating parameter of the agricultural system, or both.

13. The non-transitory computer-readable medium of claim 9, wherein the instructions, when executed by the processing circuitry, are configured to cause the processing circuitry to perform operations comprising:
receiving a request indicative of suspending operation of the agricultural system in the calibration mode; and
suspending operation of the agricultural system in the calibration mode in response to receipt of the request.

14. The non-transitory computer-readable medium of claim 9, wherein the instructions, when executed by the processing circuitry, are configured to cause the processing circuitry to perform operations comprising:
determining whether an external object is within a threshold distance of the agricultural system; and
operating the agricultural system in the calibration mode in response to a determination that there is no external object within the threshold distance of the agricultural system.

15. The non-transitory computer-readable medium of claim 9, wherein the instructions, when executed by the processing circuitry, are configured to cause the processing circuitry to perform operations comprising:
determining whether an external object is within a threshold distance of the agricultural system; and
blocking operation of the agricultural system in the calibration mode in response to a determination that there is an external object within the threshold distance of the agricultural system.

16. An agricultural system, comprising:
an agricultural implement comprising a plurality of components;
a work vehicle comprising a fluid reservoir and a plurality of valves configured to direct fluid flow between the fluid reservoir and a respective component of the plurality of components to control actuation of the plurality of components via the fluid flow;
a controller configured to perform operations comprising:
outputting respective control signals to the plurality of valves to adjust the fluid flow directed between the fluid reservoir and the plurality of components;
associating respective valves of the plurality of valves with actuation control of each component of the plurality of components based on identified actuation of the plurality of components caused by output of the respective control signals;
determining a calibration based on associating the respective valves with the actuation control of each component;
receiving an indication to actuate a target component of the plurality of components; and
outputting an additional control signal to a valve associated with the target component based on the calibration in response to receiving the indication.

17. The agricultural system of claim 16, wherein the controller is configured to perform operations comprising:
outputting a first control signal to a first valve of the plurality of valves and a second control signal to a second valve of the plurality of valves;
identifying actuation of a first component of the plurality of components in response to output of the first control signal to the first valve;
identifying actuation of a second component of the plurality of components in response to output of the second control signal to the second valve;
associating the first valve with actuation control of the first component based on identification of the actuation of the first component in response to output of the first control signal to the first valve;
associating the second valve with actuation control of the second component based on identification of the actuation of the second component in response to output of the second control signal to the second valve; and
determining the calibration based on associating the first valve with the actuation control of the first component and associating the second valve with the actuation control of the second component.

18. The agricultural system of claim 17, wherein the controller is configured to perform operations comprising:
outputting a third control signal to a third valve of the plurality of valves;
determining that actuation of a third component of the plurality of components caused by output of the third control signal to the third valve is below a threshold degree of actuation; and
outputting a notification to inspect a fluid connection between the third component and the fluid reservoir in response to determining that the actuation of the third component is below the threshold degree of actuation.

19. The agricultural system of claim 16, wherein the work vehicle comprises a first plurality of flow paths configured to enable fluid flow into and out of the fluid reservoir, the agricultural implement comprises a second plurality of flow paths configured to enable fluid flow into and out of the plurality of components, and the agricultural system comprises a plurality of connectors fluidly coupling the first plurality of flow paths and the second plurality of flow paths to one another to enable fluid flow between the fluid reservoir and the plurality of components.

20. The agricultural system of claim 19, wherein the plurality of valves is disposed along the first plurality of flow paths.
